(19) United States
(12) Patent Application Publication
(10) Pub. No.: US 2010/0073717 A1
(43) Pub. Date: Mar. 25, 2010

(54) REAL-TIME SYNCHRONIZATION OF FRONT AND BACK SIDE PRINTING IN DOUBLE-SIDED WEB PRINTING

(75) Inventor: Eddy Debaere, Deinze Asten (BE)

Correspondence Address: AGFA;c/o KEATING & BENNETT, LLP, 1800 Alexander Bell Drive, SUITE 200, Reston, VA, 20191, US

(73) Assignee: AGFA GRAPHICS NV, Mortsel (BE)

(21) Appl. No.: 12/521,137

(22) PCT Filed: Dec. 20, 2007
(86) PCT No.: PCT/EP2007/064358

§ 371 Date: Jun. 25, 2009

Related U.S. Application Data
(60) Provisional application No. 60/880,907, filed on Jan. 17, 2007.

(30) Foreign Application Priority Data
Dec. 28, 2006 (EP) 06127268.8

(51) Int. Cl. G06F 15/00

(52) U.S. Cl. 358/1.15

(57) ABSTRACT

A system and a method for synchronizing printing of images on both sides of a web in a double-sided web printer includes a method including printing a first image on a first side of the web by a first printing device; printing a second image on a second side of the web, opposite the first side, by a second printing device; sensing a position of the web, relative to the second printing device, by a web position measuring device; real-time communicating an electronic printing position signal, representative for the printing position of the first image on the web, between the first printing device and the second printing device; and printing the second image synchronized to the first image based on the electronic printing position signal and the position of the web relative to the second printing device.

### CROSS-REFERENCE TO RELATED APPLICATIONS

This application is a 371 National Stage Application of PCT/EP2007/064358, filed Dec. 20, 2007. This application claims the benefit of U.S. Provisional Application No. 60/880,907, filed Jan. 17, 2007, which is incorporated by reference herein in its entirety. In addition, this application claims the benefit of European Application No. 06127268.8, filed Dec. 28, 2006, which is also incorporated by reference herein in its entirety.

### BACKGROUND OF THE INVENTION

1. Field of the Invention

The present invention relates to double-sided printing on a web of printing substrate and concerns the synchronization of front and back side printing when these are printed by two subsequent single-sided printing mechanisms.

2. Description of the Related Art

When printing images on both sides of a web, i.e., front and back side (or recto and verso), and when two subsequent printing mechanisms are used that are positioned one after the other and that each print an image on one side of the web, i.e., on the front side and on the back side, respectively, synchronization between the two printing mechanisms is required in order to obtain correct registering of the images printed by both printing mechanisms.

Moreover, in case of, for example, transactional printing and newspaper printing, it is very important that the correct verso image is printed at the back of each recto image, which is not evident if, e.g., an error occurred during or after printing the recto image, such as a paper jam between the two printing mechanisms or a printing failure detected after printing the recto image.

To synchronize both sides, it is customary to print markers when printing the first side, e.g., the recto side, and to detect these markers when printing the second side, e.g., the verso side. For example, when printing individual, subsequent pages on the web, a marker may be printed in the margin or at the top of each page. Near the second printing mechanism that is to print the verso side, the marker is detected by an optical sensor, and the output signal of the sensor is fed to the controller of the second printing mechanism that then prints the verso side at the correct moment.

Alternatively, a web with pre-printed markers may be used, that are detected both when printing the recto side and when printing the verso side.

U.S. 2005/0024411 discloses a printer system for synchronized operations wherein two independent, fast, single-sided printing mechanisms are connected that print on the front side and the back side of a web, respectively. In order to synchronize both printing mechanisms, the length of the paper path between the printing mechanisms is determined by printing, when loading the paper web, sequential numbers on the front side of the web. Once determined, this paper path length is used to synchronize both printing mechanisms and this length is kept constant.

EP 1 520 698 to Silverbrook discloses a method for synchronizing printing on front and back surfaces of sheets of printing substrate by two printing mechanisms located opposite to each other so that they print on the same sheet at the same time.

### SUMMARY OF THE INVENTION

In view of the problems described above, preferred embodiments of the present invention include a double-sided web printer for synchronized printing of images on both sides of the web, as described below. The printer includes a first and a second printing mechanism (also referred to as printing devices) that print on opposite sides of the web. Preferably, the first and second printing devices are some distance apart (as is, e.g., the case in the prior art printer shown in FIG. 1). The double-sided web printer includes a real-time communication channel between the two printing mechanisms to communicate an electronic printing position signal from the first printing mechanism to the second printing mechanism.

The present invention also includes a method for synchronizing printing of images on both sides of a web in a double-sided web printer, as described below.

Further preferred embodiments of the invention are set out below.

An advantage of a system and method in accordance with the preferred embodiments of the invention is that the complete web area can be used for printing of the images (i.e., data, text, pictures, etc.).

Other features, elements, steps, characteristics and advantages of the present invention will become more apparent from the following detailed description of preferred embodiments of the present invention with reference to the attached drawings.

### BRIEF DESCRIPTION OF THE DRAWINGS

The present invention is described with reference to the following drawings without the intention to limit the invention thereto, and in which:

FIG. 1 shows a prior art printer that includes two printing devices that print on opposite sides of a web of printing substrate. There is no real-time communication channel between the two printing devices. Synchronization is done via printed markers on the web.

FIG. 2 shows a double-sided web printer with two printing devices and a real-time communication channel between the two for communicating an electronic printing position signal, in accordance with a preferred embodiment of the invention. The distance between the printing devices along the web is fixed.

FIG. 3 shows a double-sided web printer according to a preferred embodiment of the invention. The printer includes two printing devices, a real-time communication channel for communicating an electronic printing position signal between the two, and a communication channel for communicating image information between the two. The distance between the printing devices along the web is fixed.

FIG. 4 shows a double-sided web printer in accordance with another preferred embodiment of the invention. The distance between the printing devices along the web is variable.

### DETAILED DESCRIPTION OF THE PREFERRED EMBODIMENTS

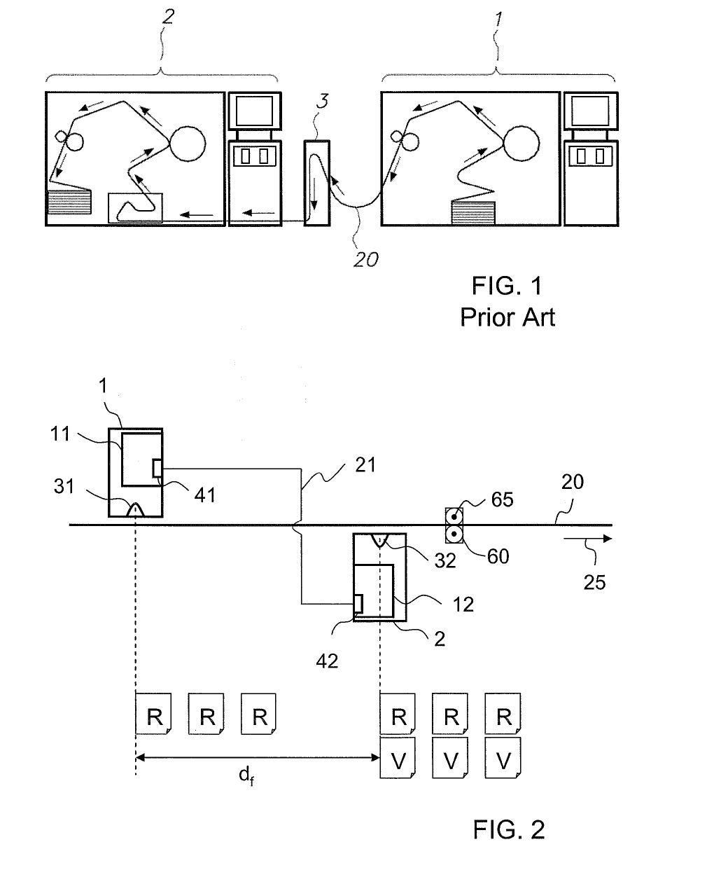

FIG. 1 shows a prior art printer including two single-sided printing units 1 and 2. The problem of synchronizing a recto image R, printed by the first printing unit 1, with a verso image V, printed by the second printing unit 2, basically is a problem in the position domain, i.e., the position of the web when printing. On the other hand, the printing itself, i.e., the controlling of the printing operation in both printing devices 1 and 2, is controlled in the time domain. A common way of synchronizing a recto image R with a verso image V is therefore to use references in the position domain, e.g., a printed marker on the web, that may be detected by the first printing unit 1 and/or the second printing unit 2 and which triggers the printing operation of the first with respect to the second printing device in the time domain. This however requires the presence of references in the position domain, affixed or printed on the web 20, and a detection device to detect the references and trigger the printing onto the web 20. Now, according to preferred embodiments of the invention, another approach for synchronizing a recto image R and verso image V is presented.

### Print Position Synchronization

FIG. 2 very schematically shows a double-sided web printer in accordance with a preferred embodiment of the invention. The printer includes two single-sided printing mechanisms or printing devices 1 and 2 that are connected with each other via a communication channel 21 to perform double-sided printing on a web 20 of printing substrate. The communication channel 21 preferably allows real-time communication, e.g., a fast hardware connection via copper wire, optical fibre, a.o. The communication channel 21 may also be wireless. The two printing units may, for example, be SPICE (Single Pass Inkjet Color Engine) printing modules used in :Dotrix Transcolor presses from Agfa Graphics. The first printing device 1 prints a recto image, such as a page shown schematically in FIG. 2 and labelled with “R”, and the second printing device 2 prints a corresponding verso image “V”. The web 20 moves in the direction of arrow 25.

In the preferred embodiment of FIG. 2, the distance along the web 20 between the first printing device 1 and the second printing device 2 is fixed and indicated with d_{f}. The first printing device 1 has a first application device 31 arranged to apply a first image on the recto side of the web 20, and the second printing device 2 has a second application device 32 arranged to apply a second image on the verso side of the web 20. The web transport is digitized by providing a web position measuring device 65 (e.g., an encoder) coupled to a web transportation device 60 (e.g., a drive roller pair), in the first printing device 1, in the second printing device 2, or in between. In the case of using an encoder device, for each revolution of the encoder axis or a portion of a revolution, a certain number of pulses is output by the encoder (e.g., 4096 pulses per revolution). The number of encoder pulses output by the encoder, over a period of time, is representative for the length of the web 20 of printing substrate moved past the encoder in the direction of the web transport, as is well known in the art. At the time instant a recto image R is printed on the web 20 by the first application device 31, the first printing device 1 sends immediately (in real-time), via its sending device 41, an electronic printing position signal to the receiving device 42 of the second printing device 2 via communication channel 21. The electronic printing position signal, in its most basic form the leading edge of an electrical pulse, is received in real-time by the receiving device 42 of the second printing device 2. This triggers the calculation of an upstream distance from the start of the printed recto image R to the second application device 32 of the second printing device 2, along the web. This upstream distance may be expressed in a number of encoder pulses of the digitized web transport, but may also be expressed in meters of web printing substrate or number of pixel lines on the web printing substrate. In the preferred embodiment of FIG. 2, this upstream distance equals the fixed distance d_{f} between the first printing device 1 and the second printing device 2. This distance d_{f} may be calculated from geometrical consideration of the web transport path through the printer or be calibrated by using a calibration marker printed or affixed onto the web and measuring a velocity of the web transport and the elapsed time for the calibration marker to be transported along the web transport path from the first printing device 1 to the second printing device 2. Equivalently, the calibration marker may be optically detected at the first printing device 1 and subsequently at the second printing device 2. These optical events may trigger an encoder device located along the web transport path to count/measure the web distance transported between the occurrence of the two triggers. So, at the start of printing the recto image R with printing device 1, printing device 2 knows, via real-time communication, the upstream distance of the start of the recto image R to its own application device. This upstream distance reduces as the web moves along its web transport path in the direction of arrow 25. When the upstream distance becomes zero, the inkjet printing device 2 starts printing the verso image R on the web.

There are various alternative methods for detecting when the start of recto image R is at the location where the verso image V is to be printed. In one preferred embodiment, the initial upstream distance, as calculated in real-time in response to receiving the electronic printing position signal, is converted to a number of encoder pulses of the digitized web transport and counted down in synchronism with the encoder signal of this digitized web transport, until a zero value is reached. In another preferred embodiment, the initial upstream distance, as calculated in real-time in response to receiving the electronic printing position signal, is converted to a number of encoder pulses of the digitized web transport, added to the actual encoder signal value at that time (i.e., the time of real-time communicating the electronic printing position signal) and stored. This stored encoder value represents the encoder value of the digitized web transport when the start of the printed recto image R is at the location where the verso image V is will be printed. The stored encoder value is then continuously compared to the actual encoder value of the digitized web transport, as the web moves along its web transport path. When the actual encoder value equals the stored encoder value, printing of the verso image V by the second application device 32 is started. Instead of using encoder values, units in the web position domain (i.e., meters) or in the time domain (i.e., seconds) may be used.

The electronic printing position signal in the preferred embodiment described above is explained as an electrical pulse generated and transmitted at the time the recto image R starts printing. In more general terms, the electronic printing position signal is an electronic reference to the position of the printed recto image R on the web. This reference is in real-time communicated from a first printing device 1 to a second printing device 2 and is used by this second printing device 2 to synchronize the start of printing the verso image V on the web, in register with the already printed recto image R. The electronic printing position signal may therefore also be implemented as an optical signal, an encoded signal or any other signal, as long as it is real-time communicated between the first printing device 1 and the second printing device 2.

The synchronization scheme discussed above is just one preferred embodiment in accordance with the invention; numerous other preferred embodiments may be realized. In a particular preferred embodiment, the electronic printing position signal is not sent at the moment the printing of a recto image R is started, but a specific time before or after that. Of course, the electronic printing position signal may not be generated and communicated too late to the second printing device 2, i.e., not after the printing of the verso image V already has to be started.

The encoder, described above as one preferred embodiment of a web position measuring device 65, may be coupled to an axis of a transportation roller of the web transport system, but any web position measuring device 65 suitable for sensing a position of a web 20 may be used. The web position measuring device may be located in or near the first printing device 1, in or near the second printing device 2 or in between the first and the second printing devices. Preferably, the web position measuring device 65 is located near the second printing device 2, more preferably near the position where the second application device 32 prints the verso image V. This significantly reduces the adverse effect, on recto/verso registration accuracy, of web tension variations in flexible media transport and jitter in the web transport. This is especially a preferred configuration when printing device 1 and printing device 2 are autonomous devices with their own controllers 11 and 12 and where the web transport system is controlled by a third controller. The web position measuring device 65 is not necessarily part of the web transportation device 60; the web position measuring device may, for example, be part of the second printing device 2 and operate independently from the web transportation device. Two or more web position measuring devices may be used; e.g., in FIG. 4 a first one 66 in the first printing device 1 and a second one 67 in the second printing device 2.

The sending device 41 and the receiving device 42 do not have to be part of the first and the second printing devices, respectively; they may just be coupled to these devices. However, they should allow real-time communication between the first and the second printing device. Real-time detection of an electronic printing position signal by the receiving device 42 of the second printing device 2, may be realized by real-time sampling of the signal received via the communication channel 21 with a high frequency signal. This high frequency signal may, for example, be the high resolution encoder signal of a web position encoder device coupled to the second printing device 2.

Each printing device 1 and 2 preferably has its own controller 11 and 12, respectively, for controlling the printing of their application devices 31 and 32, respectively; however, a central controller, that controls the printing of both the first and the second printing devices, may also be used.

When multiple recto/verso images have to be printed one after the other on the web, as will probably be the case in an industrial application, each printing start of a recto image may generate an electronic printing position signal. These electronic printing position signals are generated in real-time and form a real-time queue of successive electronic printing position signals that are sent by the sending device 41 of the first printing device 1, over the real-time communication channel 21, to the second printing device 2. Each of the plurality of electronic printing position signals within this real-time queue may be identical, e.g., a pulse of given length. The real-time queue of electronic printing position signals is received in real-time by receiving device 42 of the second printing device 2. Each electronic printing position signal in the real-time queue reflects the start of the printing of a particular recto image R by the first printing device 1 and, upon receipt by the receiving device 42, triggers the conversion into an upstream distance of that particular recto image R to the second printing device 2. Each of these upstream distance values is monitored and every time the second printing device 2 detects that an upstream distance has reached zero, or equivalent that a stored encoder value has been reached, the second printing device 2 starts printing a verso image V. Each electronic printing position signal in the queue, which is a guarantee that the printing of a corresponding recto image R has been started, results in the printing of a verso image V at the correct registered position on the web.

Preferred embodiments of the present invention provide several advantages. One advantage is that the transport velocity of the web is not required to be constant; the start of printing the recto image R on the web is real-time communicated to the second printing device and in real-time translated into an upstream distance in web length units or equivalent encoder pulses. Therefore the synchronization method is independent of time and web transport velocities. Another advantage is that a high precision can be obtained (e.g., by real-time communicating reference signals and choosing a web position measuring device with a high resolution, e.g., by connecting the encoder to the transportation axis by one or more intermediate axes with gears, in such a way that one revolution of the transportation axis corresponds to several revolutions of the encoder axis). No pre-printed or inline printed markers are required and therefore the available print area on the web is maximized. A further advantage is that preferred embodiments of the invention provide a simple implementation for recto/verso synchronization, i.e., it requires only simple I/O devices and a two-wire connection for communicating an electrical pulse (or optical signal), and a counter/comparator to create and monitor an upstream distance or encoder value. An additional advantage is also that there is no accumulation of web transport errors after a once-only calibration of the web distance between printing devices and there is no requirement for frequent re-synchronization of both printing devices, because each recto image is individually synchronized (via its own electronic printing position signal) with a verso image. Further, in the event of a break-down and subsequent start-up of the printer, the real-time queue of electronic printing position signals is automatically flushed and the recto/verso printing operation may resume immediately without wasting any web printing substrate. In prior art systems, often the web printing substrate in between both printing devices needs to be pulled through, e.g., to make sure that the second printing device isn't triggered by a wrong (non-corresponding) printed marker. Using prior art methods, the amount of printing substrate to be pulled through in, for example, a :Dotrix Transcolor printer from Agfa Graphics would be about 8 meters, and is to be considered as waste. Last, an electronic signal is a ‘clean’ signal that is either on or off and therefore is easy to interpret. Printed markers on the other hand, may not always be that clear and the optical device used to detect these markers may not react on the unclear marker or may react on printed matter different from a marker and therefore trigger erroneous printing.

### Image Synchronisation

Above, some preferred embodiments were discussed that solve the problem of correct registering of recto/verso images printed by two printing devices on the front and on the back side of a web. This registration relates to the physical position of a recto and a verso printed image on the web, i.e., the registering of these images, but it is not concerned with the content and/or the length of the printed recto and verso images.

If not all recto images are identical, with respect to content or length, and/or not all verso images are identical, with respect to content or length, an additional problem relates to the correct content of the in-register-printed recto and verso images. To some extent, assuring that the correct image content of the verso image is printed at the back of the corresponding recto image, may be solved by a proper print queue manager who takes care that recto images R in the recto print queue corresponds one to one with correct verso images V in the verso print queue. However, most problems arise when there is a malfunction in the double-sided printer, e.g., a paper jam or failing printheads, leading to a print stop and loss of synchronization of the recto print queue and the verso print queue because reprints have to be inserted. For example, recto printed images may have to be reprinted because they have not been properly verso printed. The synchronization of the verso image content to the correct recto image content may be solved by sending additional image information from the first to the second printing device, indicating which recto has just been printed. The additional image information may be incorporated in the electronic printing position signal used for print position synchronization (i.e., registration) of recto and verso images, and which is in real-time sent from the first printing device to the second printing device. In one preferred embodiment, the length of an electronic printing position signal may, for example, be encoded with an image number; that is, the leading edge of an electronic printing position pulse may define the position of the recto image on the web and the length of the pulse may define the image number of the recto image. The image information may also be encoded in an additional electronic image identification signal that is sent from the first printing device 1, over the communication channel 21, to the second printing device 2. The electronic image identification signal may be sent immediately following the electronic printing position signal.

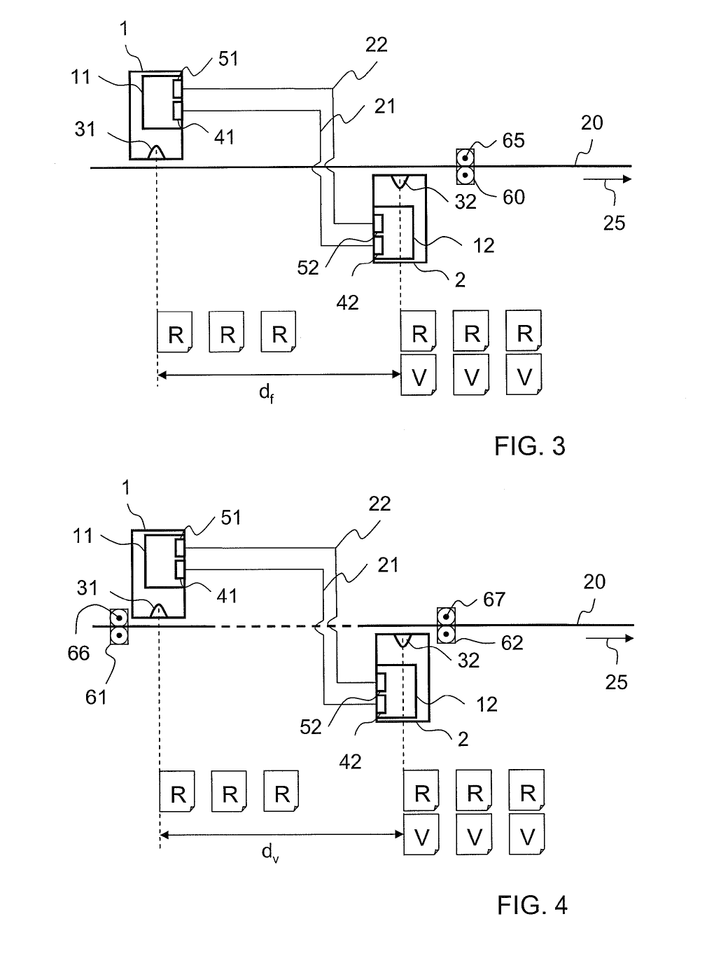

One way of encoding may be to binary code the image identification in a number of pulses, e.g., a sequence of ON/OFF pulses similar to a barcode representation. Another preferred embodiment of image synchronization may be to use an additional non-real-time communication channel 22 between sending device 51 of the first printing device 1 and receiving device 52 of the second printing device 2, as shown in FIG. 3. Communication channel 22 may, for example, be an Ethernet. It is not a requirement that communication channel 22 is a real-time communication device, because the image identification does not have to be sampled in real-time by the second printing device 2; the electronic printing position signal covers the real-time aspect of recto/verso synchronization. It is sufficient that the image identification is communicated to the second printing device 2 in time for the correct verso image V to be made available for printing when, based on the communication of the real-time electronic printing position signal, the printing of the verso image V is supposed to start. The image identification may be a page number, but may also be any other type of data suitable for image identification.

In general terms, preferred embodiments of the present invention synchronize two independent printing devices 1 and 2, printing on a single web 20. A real-time communication channel 21 between the first printing device 1 and the second printing device 2 is used to transmit a real-time electronic printing position signal from the first printing device 1 to the second printing device 2. This electronic printing position is transmitted synchronous with the printing of a reference point of the first (recto) image on the web 20. The electronic printing position signal is in real-time sampled by the second printing device 2 and converted into a corresponding upstream position of that reference point of the first (recto) image, in coordinates of the web position domain of the second printing device 2 (e.g., encoder units of the encoder device 65). Knowing the upstream position of the first (recto) image, in coordinates of the web position domain of the second printing device 2, the second printing device 2 is controlled to print the second (verso) image on the web when this upstream position of the printed first (recto) image has reached the printing position of the second application device 32.

The preferred embodiments of the present invention do not use the web position domain of the first printing device 1 to determine the reference point of the first (recto) image printed on the web. The present invention therefore eliminates the use of web position measuring devices in the first web position domain and, if such web position measuring devices were used, the present invention eliminates any conversion error of web position coordinates from the first web position domain to the second web position domain. The present invention also eliminates errors as a result of drift, different resolution or other divergences between the two web position domains.

### Re-Synchronization

In the preferred embodiments discussed above, the electronic printing position signal is in real-time converted to an upstream web position of a reference point of the first (recto) image, in the web position domain of the second printing device 2. This conversion is based on the distance, along the web transport path, between the first printing device 1 and the second printing device 2, or more specifically between the first application device 31 and the second application device 32. If this distance is fixed, see distance d_{f} in FIGS. 2 and 3, it can be deduced from geometrical consideration of the web transport path or be measured using a once-only calibration by means of a web marker. This web marker may be printed on the web by the first printing device 1 and detected at the second printing device 2, or a pre-printed marker may be used that is sensed by the first printing device 1 and subsequently also by the second printing device 2. The web distance elapsed between printing or sensing of the marker at the first printing device 1 and sensing the marker at the second printing device 2, is monitored in the web position domain of the second printing device 2 and converted into a distance d_{f} (expressed in meters or encoder pulses in the second encoder domain). The once-only calibration is preferably done after, e.g., a web roll change or a power-up of the web printer. Alternatively, the distance d_{f} may be retrieved from a two-step estimating and refining process. That is, a first step includes printing of a recto and a verso image using an estimation of the distance d_{f}; a subsequent second step then includes measuring the registration error between both printed images and adjusting the estimation of the distance d_{f} accordingly to define the correct value of d_{f}.

If the web distance between printing device 1 and printing device 2 is variable, see FIG. 4, each printing device 1 and 2 typically has its own web transportation device 61 respectively 62 (e.g., a drive roller pair) and operates within its own web position domain. Linked to the web transportation devices 61 and 62 there may be web position measuring devices 66 and 67, respectively (e.g., an encoder). Both web position measuring devices 66 and 67 are calibrated with reference to a single common web origin, which may, for example, be a single marker affixed onto the web. As the web is transported along the web transport path, this common origin is sensed by a sensing device (e.g., optical detection) in each printing device and the corresponding web position measuring device is reset to a web position origin, in the corresponding web position domain. Once both web position domains are calibrated to a common origin, the position of the web within each web position domain can be measured, for example, by a position encoder operating in that position domain. If the length between both printing devices is fixed, there would be no difference between the measured web position in either of the web position domains. However, if the length between both printing devices is variable, the difference between the measured web position in each of the web position domains would also be variable; the variation in web length dᵥ would be proportional to the variation in web position difference between the measurements in each of the web position domains.

The methods of print and image synchronization described above for a fixed web distance d_{f} between the printing devices may also be applied in a variable web distance configuration if, in addition to the real-time electronic printing position signal, also the actual web position, in the web position domain of the first printing device 1 or in a universal web position domain (e.g., a common web position domain used by both printing devices), would be communicated to the second printing device 2. This additional web position information from the first position domain, together with the actual web position information in the second position domain, allows controller 12 of the second printing device 2 to calculate the variable web distance dᵥ. As with image information data, this web position information does not need to be communicated over a real-time communication channel 21, but may, for example, be communicated over communication channel 22. However, the time of capturing or sampling the web position information (e.g., time of measuring the web position encoder value) in both web position domains, for the the purpose of later comparison and calculation of the variable web length dᵥ, preferably is synchronized. That is, web position information from both web position domains, for the purpose of determining the variable web distance dᵥ, is perferably time stamped with the same time instance. This time instance may, for example, coincide with the time of communication of the real-time electronic printing position signal between both printing devices; this time instance is a real-time instance known in both printing devices. When both printing devices, arranged with a variable web distance in between, have their own web position measuring devices, it may be sufficient to synchronize both web position measuring devices to a common reference or web origin, e.g., a web marker. This synchronization implicitely takes account of the variable web distance dᵥ. After synchronization, each web position measuring device keeps track of the absolute web position or travelled web distance from the common reference or web origin. Synchronized printing is then based on the real-time electronic printing position signal and the absolute web position linked therewith.

In a variable web distance configuration, accumulation of fault tolerances of the web position measurements may lead to drift of the web position measurements in each of the web position domains relative to the web origin. This drift may be different in the first web position domain and in the second web position domain, resulting in a different absolute web position measurement in each of the web position domains. Therefore it is preferred to regularly re-synchronize or re-calibrate both web position domains to a new common origin. This re-calibration may, for example, be preformed every 100 printed images using a printed marker, added by the first printing device, as described above.

### UP³I Standard

The so-called UP³I standard (Universal Printer Pre- and Post-Processing Interface; see www.up3i.org) is, as is the present invention, concerned with communication between printers (and moreover also with other units such as cutting devices). However, UP³I is concerned with web transport management, whereas the present invention pertains the synchronization of two single-sided printers to print, with correct registering, recto and verso images on opposite sides of a web. In UP³I, synchronization of two single-sided printers for printing a recto and a verso image, respectively, on opposite sides of a web is done via printed markers. In UP³I, so-called real-time frames are communicated between printing devices and other units to inform how much printing substrate is available between units, in order to prevent overflow of printing substrate buffers between units, or tearing of the web. This communication system allows accuracies on the order of 10 cm, which is several orders of magnitude too large to allow in-register and synchronized printing of a recto and a verso image on opposite sides of a web.

For example, the printing devices used in :Dotrix Transcolor printing systems from Agfa Graphics print at a speed of 24 m/min. At such a speed, a position accuracy of 0.1 mm (typical for registering of recto and verso images) corresponds to a timing accuracy of 250 microseconds, which can be obtained by a system according to the present invention but cannot be obtained with the real-time frames of the UP³I standard

Another difference with the UP³I standard is that in many preferred embodiments of the present invention no signals are communicated between the printing devices if no images are printed, whereas there is communication in a UP³I system as soon as there is web transport, even if no images are printed.

However, UP³I communication and print/image synchronization according to the present invention may be complementary and both may be used in an industrial print production line having a double-sided web printer configured inline with other modules such as pre- or post-coating devices, rotary cutters and folding units.

The present invention is not limited to the preferred embodiments discussed above. In further preferred embodiments, more than two printing devices may be synchronized by a method according to the present invention. Other preferred embodiments may not require recto/verso synchronization, but may, for example, require color-to-color registration when printing a color image on one side of the web, or require position synchronization between a non-personalized letter printed by a first printing device and a personalized address field printed by a second printing device.

The printing devices may, for example, be inkjet printing units having ink application devices for applying the recto and verso images on the web, but they may also be xerographic printing units.

Those skilled in the art will appreciate that numerous modifications and variations may be made to the preferred embodiments disclosed above without departing from the scope of the present invention.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-10. (canceled)

11. A double-sided web printer for synchronized printing of images on both sides of a web, the printer comprising:
a first printing device including a first application device arranged to apply a first image on a first side of the web;
a second printing device including a second application device arranged to apply a second image on a second side of the web, opposite to the first side;
a first web position measuring device arranged to sense a first position of the web relative to the second printing device;
a first controller arranged to control the first printing device to print the first image on the web and to generate an electronic printing position signal when the first image is printed on the web;
a second controller arranged to control the second printing device to print the second image synchronized with the first image; and
a real-time communication channel arranged to perform real-time communication of the electronic printing position signal between the first printing device and the second printing device; wherein
the second controller is arranged to control the second printing device to print the second image synchronized with the first image based on the electronic printing position signal and the first position of the web relative to the second printing device.

12. The double-sided web printer according to claim 11, wherein the second application device is located at a fixed distance along the web from the first application device, and the second controller is arranged to control the second printing device to print the second image synchronized with the first image based also on the fixed distance.

13. The double-sided web printer according to claim 11, wherein the second application device is located at a variable distance along the web from the first application device, the double-sided web printer further comprising a second web position measuring device arranged to sense a second position of the web relative to the first printing device, and wherein the second controller is arranged to control the second printing device to print the second image synchronized with the first image based also on the second position of the web relative to the first printing device.

14. The double-sided web printer according to claim 11, wherein the electronic printing position signal includes an image identification of the first image printed on the web, and the second controller is arranged to control the printing of the second image to correctly correspond to the first image.

15. The double-sided web printer according to claim 12, wherein the electronic printing position signal includes an image identification of the first image printed on the web, and the second controller is arranged to control the printing of the second image to correctly correspond to the first image.

16. The double-sided web printer according to claim 13, wherein the electronic printing position signal includes an image identification of the first image printed on the web, and the second controller is arranged to control the printing of the second image to correctly corresponding to the first image.

17. The double-sided web printer according to claim 11, further comprising a communication channel arranged to communicate an image identification of the first image printed on the web between the first printing device and the second printing device, and the second controller is arranged to control the printing of the second image to correctly correspond to the first image.

18. The double-sided web printer according to claim 12, further comprising a communication channel arranged to communicate an image identification of the first image printed on the web between the first printing device and the second printing device, and the second controller is arranged to control the printing of the second image to correctly correspond to the first image.

19. The double-sided web printer according to claim 13, further comprising a communication channel arranged to communicate an image identification of the first image printed on the web between the first printing device and the second printing device, and the second controller is arranged to control the printing of the second image to correctly correspond to the first image.

20. The double-sided web printer according to claim 11, further comprising a device arranged to print a marker on the web to calibrate a distance between the first printing device and the second printing device.

21. The double-sided web printer according to claim 12, further comprising a device arranged to print a marker on the web to calibrate a distance between the first printing device and the second printing device.

22. The double-sided web printer according to claim 13, further comprising a device arranged to print a marker on the web to calibrate a distance between the first printing device and the second printing device.

23. The double-sided web printer according to claim 11, wherein the first printing device and the second printing device are inkjet printing devices.

24. The double-sided web printer according to claim 12, wherein the first printing device and the second printing device are inkjet printing devices.

25. The double-sided web printer according to claim 13, wherein the first printing device and the second printing device are inkjet printing devices.

26. A method of synchronizing a double-sided web printer for printing images on both sides of a web, the method comprising the steps of:
providing a first printing device arranged to print a first image on a first side of the web;
providing a second printing device arranged to print a second image on a second side of the web, opposite to the first side;
measuring a first position of the web relative to the second printing device;
printing the first image on the web and generating an electronic printing position signal when the first image is printed on the web, and printing the second image synchronized with the first image; and
real-time communicating the electronic printing position signal between the first printing device and the second printing device, and printing the second image synchronized with the first image based on the electronic printing position signal and the first position of the web relative to the second printing device.

27. The method according to claim 26, further comprising the steps of:
communicating an image identification signal of the first image printed on the web between the first printing device and the second printing device; and
controlling the printing of the second image to correctly correspond to the first image based on the image identification signal.

28. The method according to claim 26, further comprising the steps of:
measuring a second position of the web relative to the first printing device; wherein
the step of printing the second image synchronized with the first image is also based on the second position of the web relative to the first printing device.

29. The method according to claim 27, further comprising the steps of:
measuring a second position of the web relative to the first printing device; wherein
the step of printing the second image synchronized with the first image is also based on the second position of the web relative to the first printing device.
